(19) United States
(12) Patent Application Publication
(10) Pub. No.: US 2008/0243662 A1
(43) Pub. Date: Oct. 2, 2008

(54) System and method for electronic contracting

(75) Inventor: T.N. Subramaniam, Troy, MI (US)

Correspondence Address: THELEN REID BROWN RAYSMAN & STEINER LLP, PO BOX 640640, SAN JOSE, CA, 95164-0640, US

(73) Assignee: Route One, LLC

(21) Appl. No.: 12/002,016

(22) Filed: Dec. 14, 2007

Related U.S. Application Data
(63) Continuation-in-part of application No. 11/694,230, filed on Mar. 30, 2007.
Application No. 11/694,230 is a continuation-in-part of application No. 11/834,378, filed on Aug. 6, 2007.

(51) Int. Cl. G06Q 40/00

(52) U.S. Cl. 705/35; 705/38

(57) ABSTRACT

A system and method for generating, executing and maintaining electronic contracts in connection with indirect financing transactions involving an acquisition by a customer of an asset offered by a vendor with financing provided by an independent finance source. In one example embodiment, the system includes an e-contracting application that generates an electronic contract based on the one or more contract templates provided by the finance source and information provided by the customer. The e-contracting application provides the generated contract to one or more contracting parties, including the customer, the vendor and the finance source. The application then receives one or more holographic signatures indicating execution of the contract by the contracting parties and generate an e-contract package by digitally signing each one of the electronic contract and the one or more holographic signatures using one or more digital signatures. The application then stores in a database the digitally signed e-contract package and one or more digital certificates associated with one or more digital signatures.

### CROSS-REFERENCE TO RELATED APPLICATIONS

The present application is a continuation-in-part of U.S. patent application Ser. No. 11/694,230, filed on Mar. 30, 2007, and a continuation-in-part of U.S. patent application Ser. No. 11/834,378, filed on Aug. 8, 2007, all commonly owned herewith and both of which are incorporated by reference herein.

### FIELD OF THE INVENTION

The present invention relates generally to a system and method for electronic contracting, and more particularly, electronic contracting in indirect financing transactions.

### BACKGROUND

In the past, the process for generating, assigning, discounting and funding contracts in indirect financing transactions, such as automobile financing and other consumer credit transactions, was driven by the completion and processing of pre-printed paper forms. A dealer would complete the required pre-printed forms, enter into the contract with the customer, assign the contract and related documents to the finance source, e.g., a bank or other financing company, and then physically bundle and deliver the paper contract package (via courier or mail) to the finance source's sales branch. Once the documents were received, the sales branch would manually enter the required data from the contract packages into a computer system. Once data and plan validation were complete, and any remaining issues were resolved, the contract would be released for funding. After the contract was funded, the sales branch would then re-bundle the contract package and forward it to another application or supplier to scan or image the paper contract for account servicing purposes.

Recent advances in the computer and telecommunication technologies, however, have had a significant impact on the way financing transactions are conducted. For example, electronic exchange of information, including faxing, emailing, and the like, between dealership finance and insurance staff has enabled dealers to electronically initiate financing transactions for their customers with various independent finance sources, thereby enhancing both the efficiency and accuracy associated with securing consumer financing. However, current e-contracting solutions are only partially automated due to security concerns and lack of integration and cooperation between dealerships and various finance sources. Accordingly, there is a need for an improved e-contracting system that facilitates electronic contract creation, execution and storage and makes available the contracts and related information to dealers and various finance sources in a secure and reliable manner.

### Overview

Computer-implemented systems and methods for electronic contracting in indirect financing transactions described herein provide an improved e-contracting environment in which a customer may acquire an asset (such as, for example, an automobile) from a dealer or other vendor with financing for the transaction provided by an independent finance source.

### BRIEF DESCRIPTION OF DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a schematic diagram illustrating one example embodiment of a system for implementing financing transactions in connection with an acquisition of an asset such as an automobile;

FIG. 2 is a schematic diagram illustrating one example embodiment of a database for a credit aggregation management system;

FIGS. 3A and 3B are process flow diagrams illustrating various example embodiments of processes for facilitating asset financing transactions; and

FIGS. 4 and 5 are schematic diagrams illustrating example embodiments of data structures for storing e-contract data.

### DETAILED DESCRIPTION OF EXAMPLE EMBODIMENTS

Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

As will be understood, for purposes of clarity of exposition, the illustrative embodiments described herein in connection with the drawing figures relate to system and methods for facilitating electronic contracting in the context of indirect financing transactions, such as buying or leasing an automobile offered for sale or lease by an automobile dealership with financing provided by one or more independent finance sources. Example embodiments described herein, however, are not limited to such automobile retail environments and automobile vehicle financing applications, but may be implemented in myriad other commercial transaction environments and asset financing transactions, including both unsecured and secured credit applications and financing. Furthermore, vehicle financing transactions may involve vehicles other than automobiles (e.g., including cars and trucks), such as boats and other watercraft or marine vehicles, recreational vehicles, motorcycles, off-road vehicles, aircraft and the like.

A financing transaction, as used herein, may be a lease transaction, a loan transaction, or any other transaction in which a finance source provides financing for a party to obtain use of, and possibly also legal title to, an asset, which asset includes, for example, one or more items such as automobiles (e.g., cars, trucks, and the like), marine, recreational vehicles (RV), aircraft, motorcycles, off-road vehicles, consumer goods, real estate, contract rights, intangible property rights, home furnishings, home improvement, office equipment, inventory, manufacturing equipment, livestock, farm equipment, financial interests, and so on. Additionally, for convenience, as used herein, the term “acquisition” used in connection with an asset (e.g., an “asset acquisition” or “acquiring an asset”) may involve a purchase (i.e., buying or a corresponding sale) or a lease of the asset, and thus a financing transaction relating to an acquisition may be a lease transaction, a loan transaction, or any other transaction in which a finance source provides financing for a party to obtain use of, and possibly also legal title to, the asset.

A contract, as used herein, may be a document prepared in connection with a transaction for the purchase or financing of a vehicle offered for sale by the dealer with financing provided by a finance source or other types of transactions described above. The contract may include a plurality of contact provisions, information describing the customer, information describing the automobile, information describing the financial program, and a plurality of signature fields. The contract may be considered executed when it is signed by all contracting parties at the appropriate signature fields. Thus, in one example embodiment, the contract may be executed (e.g., signed) by the customer and the dealer, and then transferred (e.g., assigned) by the dealer to the finance source. In alternative embodiments, the contract may be executed by the customer, the dealer and the finance source. Once executed, the contract becomes a legal instrument that binds the contracting parties to the contract provisions contained therein.

In one example embodiment, the contract may be generated in an electronic form (i.e., electronic contract) and printed by the dealer for review and execution by the contracting parties. The electronic contract may be created as a text document, postscript document, image file or other type of electronic document. The printed copy of the electronic contract may be executed in the following manner. In one example embodiment, a paper copy of the contract may be signed by the contracting parties, the signature may be scanned by a signature capture device and appended to the electronic version of the contract (i.e., electronic contract). In alternative example embodiment, an electronic signature pad may be used to sign an electronic version of the contract and the signature may be appended to the electronic contract. The captured image of a handwritten signature will be referred herein as a holographic signature.

Additionally, while some example embodiments are described in connection with a transaction involving personal communication (e.g., face-to-face, telephonic, and the like) between a customer and a dealer at a brick-and-mortar dealership, alternative embodiments may be implemented in an e-commerce or online shopping environment (e.g., an online automobile dealer), where a customer may remotely browse an online retailer's website for locating and buying or leasing inventory offered for sale or lease by the online retailer, though such e-commerce or online shopping may also involve some communication between customer and an employee or human agent of the online dealer (e.g., to obtain additional information and/or effect all or part of the transaction). Furthermore, a dealer is not limited to an automobile dealer, but is any individual or entity (e.g., commercial dealership, third party brokers, vendors, retailers, and manufacturers) in the business of selling or leasing assets, including merchandise, to customers, and in doing so may communicate with lenders as well as customers.

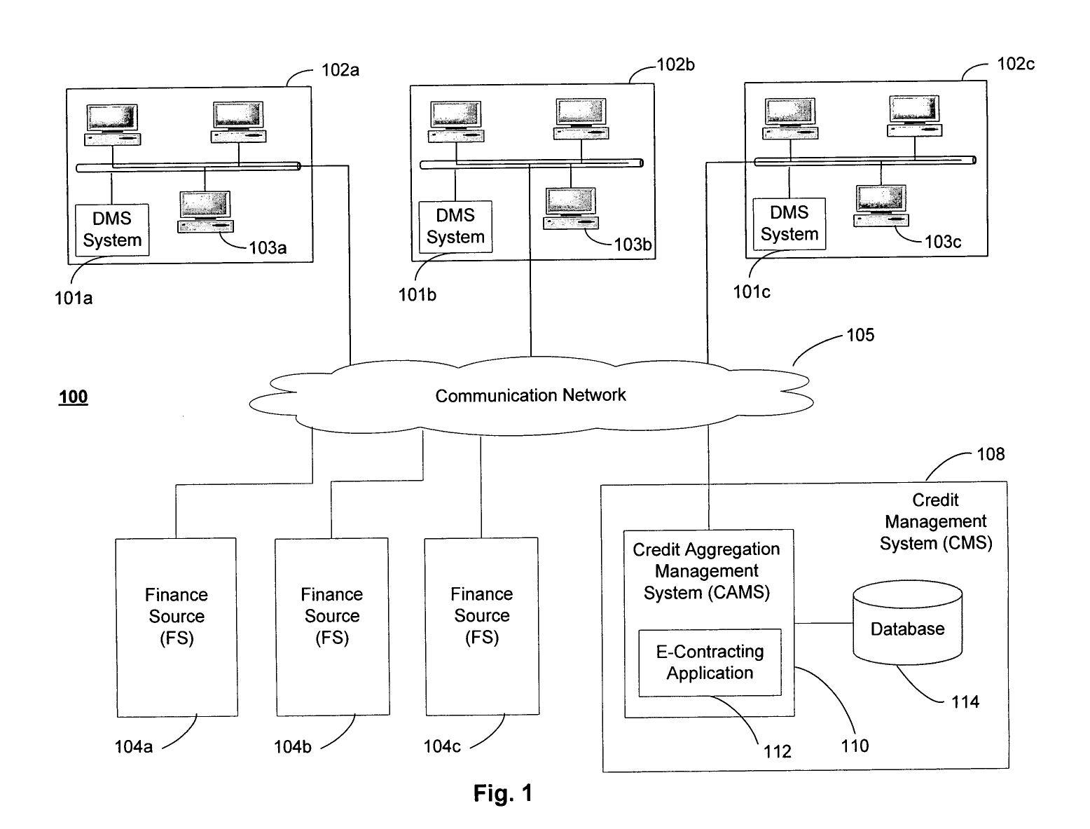

FIG. 1 is a schematic diagram illustrating one example embodiment of a system for implementing financing transactions in connection with an acquisition of an asset such as an automobile. System 100 comprises automobile dealership computer systems 102a, 102b, 102c, finance source (FS) systems 104a, 104b, 104c, and a credit management system (CMS) 108. Communications between the various dealerships 102, FS systems 104 and CMS systems 108, as may be required according to various embodiments of the present invention, are provided via communications network 105, which may include any configuration of private and/or public communication networks, packet switched local area networks (LAN) and wide area networks (WAN). In one illustrative embodiment, network 105 includes the Internet or a data communications network providing similar functionality. Dealership, FS systems, and CMS systems may communicate using messaging formats and protocols known in the art, such as XML-based messaging according to STAR (Standards for Technology in Automotive Retail), and the like.

In one example embodiment, finance source (FS) systems 104 provide processing platforms for processing credit applications for financing (e.g., loans and/or leases) an automobile being offered for sale by a dealer to a customer. Examples of finance sources 104 include Lexus Financial Bank®, BMW Financial Services, General Motors Acceptance Corporation (GMAC®) Financial Services and others. Embodiments of the present invention, however, are not limited to such automobile retail environments and automobile vehicle financing applications, but may be implemented in myriad other commercial transaction environments and asset financing transactions, including both unsecured and secured credit applications and financing. Accordingly, a finance source (also referred to herein as a lender) may be considered as any entity providing financing for asset (e.g., automobiles in an example embodiment of FIG. 1) transactions, e.g., banks and credit unions, manufacturer-related financing companies, financial institutions, and other credit granting institutions.

In one example embodiment, dealerships 102 may be independent automobile dealerships (e.g., separately owned businesses) and, as schematically depicted, each including a computer network comprising one or more computer devices 103 communicably coupled to a Dealer Management System (DMS) 101, which may be operating on one or more servers on the dealership's computer network. As will be understood by those skilled in the art, the illustrative dealership computer devices 103 are not limited to personal computers, terminals, or workstations, nor limited to wired network connections within the dealership, but may include any computing device that may communicably connect (e.g., wirelessly; via a WAN, via a virtual private network (VPN) connection, via the Internet, etc.; via one or more hardware devices, such as routers, switches, hubs, etc.; and using any of a variety of communication protocols; etc.) to the Dealer Management System 101.

As known to those skilled in the art, a typical DMS 101 (e.g., such as provided by ADP, Inc. or Reynolds and Reynolds, Inc.) or similar system stores and manages dealership data such as that related to inventory, sales, parts, service, customers, etc. In use, the DMS 101 allows salespersons, management, and other authorized users to access stored dealership data. For example, a salesperson may access DMS 101 via a computer device (e.g., 103a) to determine whether the dealership has a certain vehicle in its existing inventory. In addition, as will be further understood below, in various embodiments of the invention, a dealer assisting a customer in arranging for financing to complete the automobile transaction (e.g., lease or sale) may use a dealership computer 103 to access the DMS 101 to acquire vehicle information (and possibly also information for a return customer), and may also access (e.g., navigating via a web browser) Credit Management System (CMS) 108 (e.g., which may be a web-based application) to arrange for financing of the vehicle from finance sources 104.

In one example embodiment, the credit management system (CMS) comprises one or more computer servers connected to the communication network 105. CMS system 108 may be provided by an independent application service provider (ASP), though in various embodiments such a system may be provided, for example, by one or more affiliated dealers. In an embodiment of the invention, CMS 108 is operable to assist automobile dealers in obtaining automobile financing for customers from disparate finance sources 104. To that end, CMS 108 maintains secure, separate accounts for each independent dealership participant (e.g., subscriber) of the credit management system, which automobile dealer may access via communication network 105 (e.g., via a secure (e.g., encrypted) communication link). As indicated above, while CMS computer system 108 is depicted as a computer server 108, generally, CMS 108 may be implemented as, or be part of, a multi-server environment having access to multiple databases to provide such a platform (e.g., including geographically dispersed servers to provide service to geographically dispersed dealers).

To facilitate electronic execution of indirect financing transactions between customers and various finance sources, CMS 108 comprises a credit aggregation management system (CAMS) 110 and a database 114 in accordance with one example embodiment. CAMS 110 may be implemented as a web-based application, providing independent dealerships (e.g. 102a, 102b, 102c) a common platform for electronically submitting automobile financing applications to one or more finance sources (e.g., finance sources 104a, 104b, 104c) with which they do business. Although CAMS 110 is illustrated as being hosted by the web server 108, system 110 may reside in other locations in the system 100. In some example embodiments, one or more of these modules, or portions thereof, may be incorporated into a dealership's local DMS (e.g., DMS 101a). Additionally, in various embodiments, DMS 101, or portions thereof, may be implemented as a web-based service, similar to CMS 108, and in some implementations such a web-based DMS system, or portions thereof, may be bundled or included with, or otherwise operate as part of, the web-based CMS 108. In short, the particular details of the system 100 may vary depending upon the particular application or embodiment of the present invention.

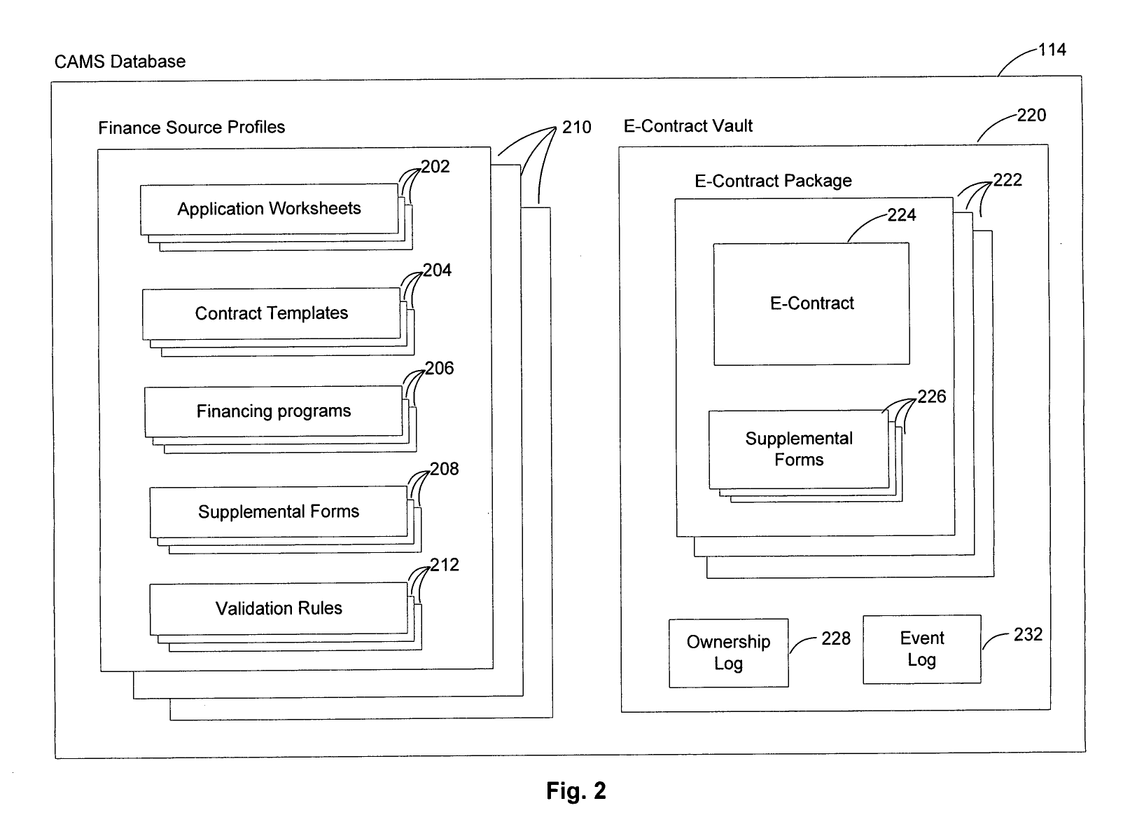

In one example embodiment, CAMS 110 facilitates collection of information about available automobile financing programs from FS systems 104. FIG. 2 is a schematic diagram illustrating one example embodiment of a database 114 for a credit aggregation management system 110. Referring now to FIG. 2, the collected information may be stored in the finance source (FS) profiles 210. In some embodiments, finance source profile information stored in FS profiles 210 may include, but is not limited to, application worksheets 202, which may include applicant worksheets for collecting personal information about the customer and deal worksheets for collecting financial information and vehicle information. FS profiles 210 may also include financing programs information 206, which may include information on the term of available loan and lease programs, including their amortization and interest rates and other financial information. FS profiles 210 may also store supplemental forms 208, which may include retail loan agreements, lease agreements and other financial forms, that may be provided to the customer in connection with the financing of the vehicle. FS profiles 210 may also include various application validation rules 212, which may be used to check validity of application data entered by the dealer before it is being submitted to the finance source for approval. FS profiles 210 may also include contract templates 204, which are used to generate electronic contracts based on approved credit applications, as will be discussed in a greater detail below.

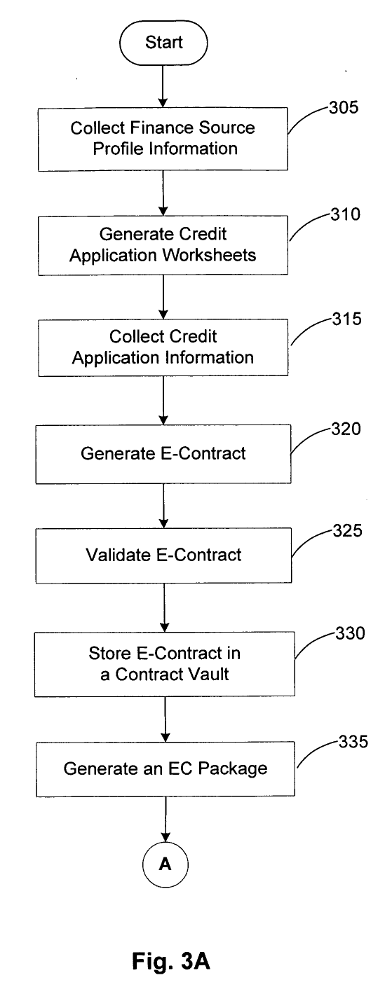

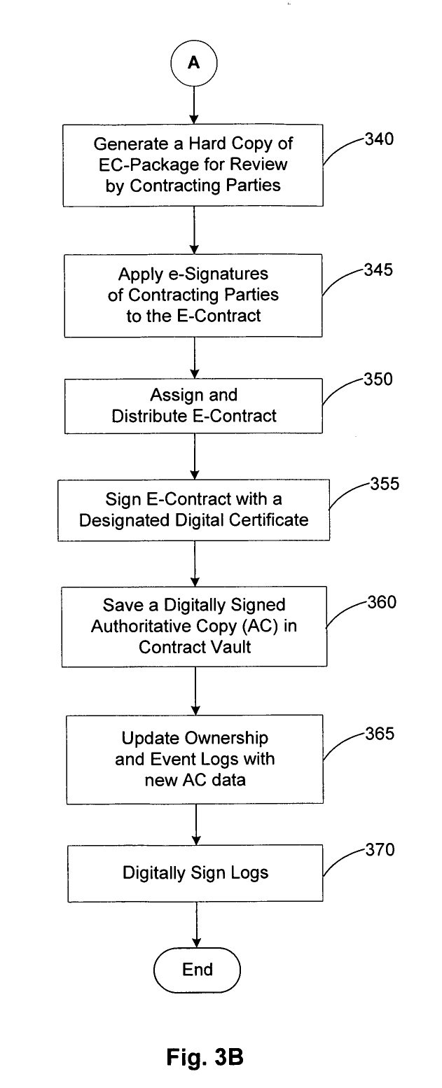

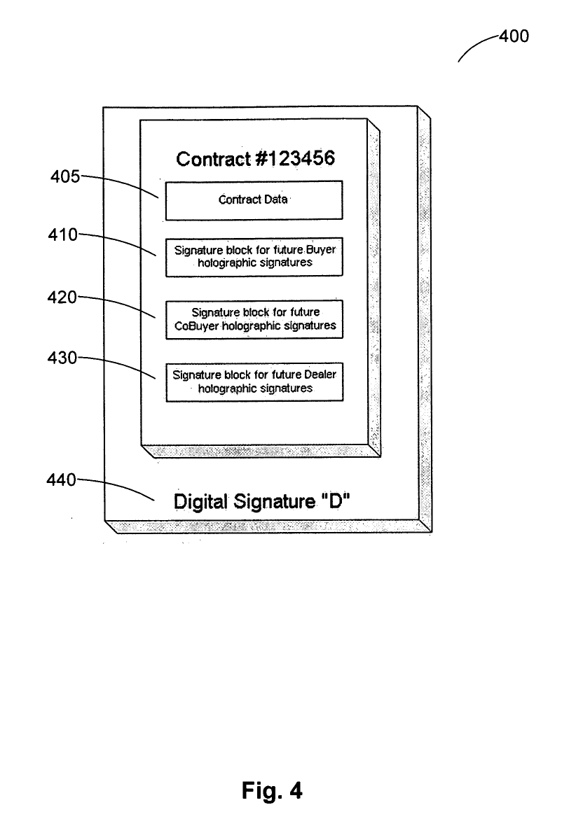

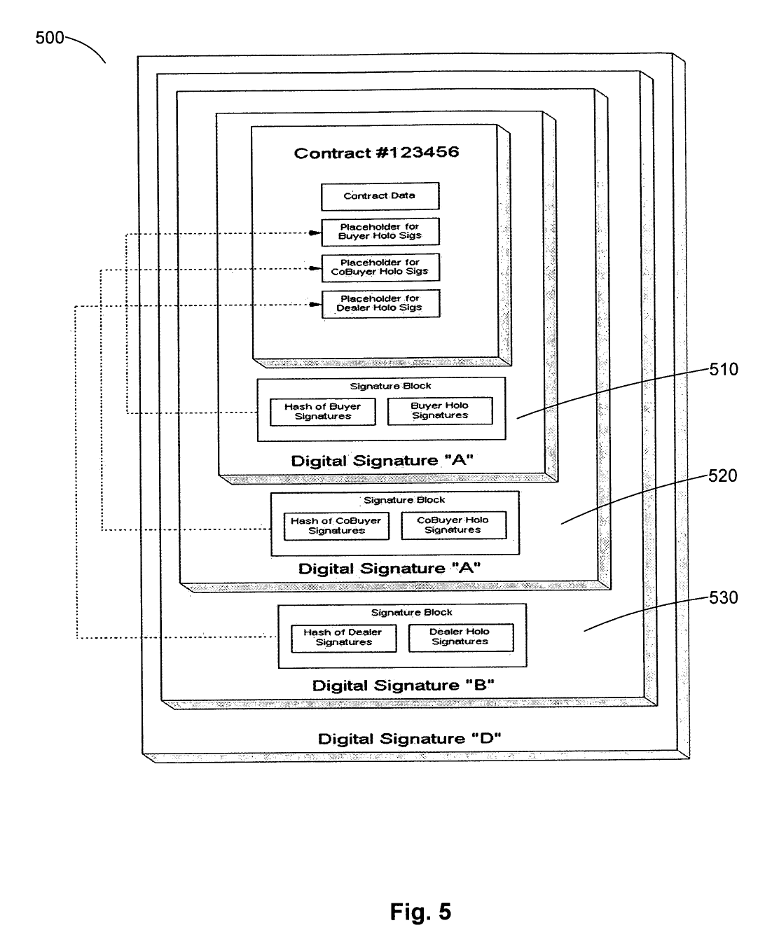

In one example embodiment, CAMS 110 further comprises an e-contracting application 112, which includes program logic for facilitating electronic creation of credit applications, execution of e-contracts based on applications approved by finance sources 104, and storage and maintenance of executed e-contracts in e-contract vault 220 in the database 114. E-contracting application 112 may be implemented as an internal software component of CAMS 110, though as will be understood by those skilled in the art, the e-contracting functionality may be provided as a separate application running on the same or different server as the CAMS 110. Operation of e-contracting application 112 and in particular the process of creating, executing, storing and maintaining e-contracts for financing of automobile purchases and the like will be described next with reference to FIGS. 3A, 3B, 4 and 5. The operational steps of the e-contracting process of FIG. 3 will be described herein with further reference to system 100 (FIGS. 1-2) and example electronic contracts depicted in FIGS. 4 and 5.

With reference to FIG. 3A, at step 305, CAMS 110 facilitates collection of finance source profile information from various finance sources and storage of the collected information in the database 114. In one example embodiment, finance source profile information may be orally communicated to CMS administrators by representatives of finance sources 104. System administrators may then manually enter the provided information into FS profiles 210 and code various credit application validation rules 212 using conditional expressions using, for example, Java, C++ or other known programming languages or via a rule engines, such as Drools® available from Red Hat, Inc. of Raleigh, N.C. or JESS® available from Sandia Corporation of Livermore, Calif. Alternatively or additionally, CMS 108 may provide a graphic user interface, such as one or more webpages, by which FS representatives may submit information into CMS 108. In one example embodiment, CAMS 110 exposing a plurality of application program interfaces (API), such as XML-based APIs, which can be used by FS systems 104 to connect CMS 108 to DMS systems 101. FS profiles 210 may be periodically (e.g., hourly, daily, weekly, and the like) updated by finance sources 104 to reflect changes to business objectives, financial arrangements and economic conditions associated with financing of vehicles. Such changes may include, for example, changes to various interest rates, tax rates, limits of financing amounts, special promotions (e.g., 0% APR for 6 months), as well as other financing parameters.

At step 310, CAMS 110 generates of one or more credit application worksheets 202 based on the collected finance source profile information. Application worksheets 202 may include financing programs information 206, such as information on the term of available loan and lease programs, including their amortization and interest rates and other financial information. In one example embodiment, application worksheets 202 are used by the dealer to collect personal and financial information about the customer, as well as information about a vehicle being financed, step 315. Application worksheets 202 may be electronically completed by the dealer based on the customer's answers. In alternative embodiments, worksheets 202 may be printed out and completed by the customer. In one example embodiment, CAMS 110 uses information provided in the application worksheets 202 to generate a credit application and submit it to the appropriate FS 104 for approval. Various embodiments of a process for credit application validation and approval are described in a greater detail in a commonly owned U.S. patent application Ser. No. 11/834,378 entitled “System and Method for Validating Indirect Financing Transactions,” which is incorporated by reference herein in its entirety.

Once the credit approval is received from the finance source, the e-contracting application 112 may generate an electronic contract for financing of a vehicle by the customer, step 320. In order to create a contract, application 112 may first determine the type of the contract that is being created and retrieves an appropriate contract template 204 from the database 114 in accordance with one example embodiment. Factors that are used by the e-contracting application 112 in determining an appropriate contract template include, but are not limited to, (i) the finance source, (ii) the state in which transaction is being conducted, (iii) the transaction type, such as retail, lease, balloon and the like, (iv) the product type, such as simple interest method, standard, single pay, and the like, (v) the vehicle sales class, such as new, used, certified used and others, and (vi) the application type, such as individual, individual with co-applicant and the like. In alternative example embodiment, e-contracting application 112 may prompt the dealer to identify the type of contract that is being created and retrieved a corresponding contract from database 114.

Once the appropriate contract template 204 is identified, the e-contracting application 112 may populate the contract template 204 with available information in accordance with one example embodiment. For example, the template 204 may be populated with information retrieved from the credit application and other sources. Such information may include, but is not limited to, all available customer information, financing information, vehicle information, dealer information, finance source information and other types of data. The e-contracting application 112 may populate the appropriate data fields in the contract template 204 with the retrieved information. In addition, the e-contracting application 112 may perform various calculations on the data in the contract template 204, such as addition/subtraction/Truth-In-Lending Disclosures—APR and finance charge tolerance, and the like, to assist the dealer in completing the contract template. The dealer may be responsible for accurately performing the detailed calculations, such as taxes and fees, by using a Dealer Management System (DMS).

Once all required information has been entered into the contract template 104, the e-contracting application 112 may validate the contract information for accuracy, step 325. The validation process may be twofold. First, the e-contracting application 112 may perform its internal data validation to ensure that all contract data is valid. For example, the system may check that the customer name field does not contain any numeric characters or that the social security field contains exactly nine digits and the like. Second, once the internal contract validation is complete and all incorrect data has been corrected by the dealer, the e-contracting application 112 may submit the contract data to the appropriate finance source for validation. Finance source validation may include the verification of the contract data against the proper plan/rate selection, vehicle selection, and approved credit decision guidelines, and the like.

In one example embodiment, the finance source's validation results may be electronically communicated back to the dealer and displayed on the user interface provided by e-contracting application 112. These results will inform the dealer of any validation failures and the necessary corrections prior to contract generation. If the dealer can make necessary correction to the data in the contract template 204 at this point, the dealer may be required to re-validate with the same finance source before the e-contracting application 112 allow the dealer to generate the final contract. This re-validation benefits the dealer by ensuring that the unsigned contract has the most current data completely validated by the finance source 104. This will also expedite the finance source's discounting and funding process.

Once the contact data has been validated by the appropriate finances source 104, e-contracting application 112 may generate an electronic contract for vehicle financing. In addition, e-contracting application 112 may assign a unique contract identifier to the newly created contract. This contract identifier may be used to identify and properly route the data in all communications and messaging that may occur between CMS 108 and finance source 104 in connection with execution of this electronic contract.

In one example embodiment, e-contracting application 112 may store a newly created (unexecuted) contract in a contract vault 220, step 330. One example embodiment, of a structure for storing a newly created e-contract is depicted in FIG. 4. As shown data structure 400 may include an e-contract 405 and a plurality of signature blocks 410-430, where holographic signatures of contracting parties may be inserted once the contract is executed. When an e-contract 405 is first created in the contract vault 220 it may be secured with a digital signature 440, such as a digital signature D, which will be described in a greater detail below with reference to FIG. 5. In one example embodiment, e-contracting application 112 may assign a transaction number or other identifier to each new contract created in contract vault 220. The transaction number or other identifier may be used as the primary key in storing contract documents in the contract vault 220. The transaction number may be different from the contract identifier described above.

Once the e-contract has been created from contract template 204, the dealer can generate the required EC Package by systematically merging the contract data with various contract forms and ancillary documents, such as supplemental forms 208, step 335. Each finance source may be responsible for creating its own contract forms and ancillary documents and ensuring that each is accurate and compliant with all applicable local, state and federal laws and regulations. The e-contracting application 112 may access these forms as required for e-contracting from FS profiles 210. For each applicable deal type, the finance source may identify the contract forms to be used. For example, the deal type may determined based on the six deal type parameters selected by the dealer: finance source, application type (e.g., individual, individual with co-buyer), transaction type (e.g., retail), product type (e.g., simple interest, actuarial), state, and sale class (e.g., new, used). Each contract form may explicitly indicate that the customer is agreeing to conduct the transaction electronically and agreeing to use electronic records and electronic signatures to document the contract. The dealer may also ask the customer to provide various ancillary document, which may then be faxed or transmitted to CMS 108 using mail or other means. The received documents are then appended to EC package.

Next, e-contracting application 112 may require the dealer to generate and print a review copy of the EC package, step 340. To that end, e-contracting application 112 may extract a copy of the forms and documents making up the EC package from the contract vault 220 and/or FS profiles 210 in CMS database 114. Simultaneously, the e-contracting application may mark in the margin(s) of each document that the documents is review copy only and not authoritative. Each document will be rendered and presented to the dealer. The dealer will then have to submit each document for printing before being allowed to continue. The dealer will be required to present the customer with a printed review copy of the EC package prior to having the customer electronically sign any of the contract package documents. The review copy will have a tracking number, i.e. the contract identifier printed on the contract for the purpose of identifying the document during the signature process. This review copy may have all signature fields blacked out and will be marked as a review copy; otherwise it will be identical to the electronic version that the customer will be electronically signing.

Once the customer(s) has reviewed the review copy of the contract package, the dealer may initiate the signature process, step 345. An electronic, handwriting signature pad device may be attached to the dealer's PC and may be used to capture both the customers' and the dealer's electronic holographic signatures. The signature pad may display text describing the applicable disclosures from the contract form for each section the customer is signing, a reference label to the applicable section of the review copy (e.g. Signature Line A), along with the tracking number tying the review copy, authoritative copy and completed copy of the contract together, ensuring that the customer is reviewing and signing the same document. As the customer signs the signature pad, his signature will appear simultaneously on the dealer's PC. The e-contracting application 112 may record the date and time that each signature was captured. Holographic signatures will not be reused during the e-contracting process; each signature field will be electronically mapped to one specific line on the contract. The customer will have the option to cancel or clear a signature as desired during signing process, and the system will notify the user if the electronic signature is not captured correctly.

In one example embodiment, the e-contracting application 112 may store the signing party's signature on the dealer's desk top computer until all required signatures have been completed on a document by the signing party. When the signing party has completed the signing process on a document, the e-contracting application 112 may affix each holographic signature onto the pre-designated line on the e-contract in the CMS database 114. The signatures will be affixed in such a way that the date and time of each signature capture, as well as the authenticity of each unique signature is embedded in the e-contract. At this point, the dealer is able to save and exit the contract generation process if necessary in order to return at a later time for the remaining party(s) to complete all required signatures. After all required signatures have been obtained, the e-contracting application 112 will update the electronic contract from a signatures-in-process status to an Authoritative Copy (AC) of the e-contract in the vault.

Once the AC of the e-contract has been created, the dealer is ready to assign and distribute the contract to the finance source, step 350. The dealer may invoke the ‘Assign Contract’ function provided by e-contracting application 112. The system will display the finance source as the assignee to which the contract will be sent, and state that by clicking the “Assign” button the dealer is assigning the contract to the finance source under the terms and conditions of the dealer agreement governing such assignments. Once this is completed, the e-contracting application will enable the ‘Distribute’ function to the dealer. The offer and acceptance of such assignment shall be affected electronically and recorded by the e-contracting application 112. After the contract assignment is accepted by the finance source, the ownership logs will be updated and the finance source will become the assignee of record. All such transactions shall be included in the ownership logs and event logs.

The e-contracting application 112 may then permanently seal the electronic contract using a designated digital certificate that is reserved solely for signing the Authoritative Copy of a contract, step 355. The presence of this digital certificate, as obtainable through the digital signature, will identify it as the Authoritative Copy. Upon saving the Authoritative Copy in the contract vault 220, step 360, the e-contracting application 112 may update the contract ownership logs with the dealer ownership information. The system will enable the dealer to print the entire signed contract package once all required signatures have been affixed to the contract package documents. The printed contract package document will be marked in the margin(s) as a non-authoritative completed copy. It will be the dealer's responsibility to ensure that the customer is provided with a printed copy of the signed EC package before leaving the dealership.

In one example embodiment, several different digital certificates for digital signatures may be used in the e-contracting process. A digital signature is data that binds a sender's identity to the information being sent. A digital signature may be bundled with any message, file, or other digitally encoded information, or transmitted separately. Digital signatures are used in public key environments and provide authentication and integrity services. A digital certificate is a digitally signed statement that contains information about an entity and the entity's public key, thus binding these two pieces of information together. A certificate may be issued by a trusted organization (or entity) called a certification authority (CA) after the CA has verified that the entity is who it says it is. Certificates can contain different types of data. For example, it can include the format of the certificate, the serial number of the certificate, the algorithm used to sign the certificate, the name of the CA that issued the certificate, the name and public key of the entity requesting the certificate, and the CA's signature.

FIG. 5 depicts one example embodiment of the digitally signed Authoritative Contract utilizing four different types of digital certificates: “A”, “B”, “C”, and “D”.
Certificate “A” may be used in all digital signatures performed on documents prior to the creation of the authoritative contract. The holographic signature of buyer from the signature pad may be associated with the signature block 510 from the contract and digitally signed using the key from Certificate “A”.
Certificate “B” may only be used to create digital signatures performed by system on the dealer's behalf, on documents in order to represent that the contract has become the Authoritative Copy. The holographic signature of co-buyer from the signature pad may be associated with the signature block 520 from the contract and digitally signed using the key from Certificate “B”.
Certificate “C” may be used for digital signatures to represent that the finance source has accepted the contract purchase. Each finance source will procure a digital certificate and provide both the private and public key to e-contracting application 112 for this purpose. The holographic signature of the dealer from the signature pad may be associated with the signature block 530 from the contract and digitally signed using the key from Certificate “C”.
Certificate “D” may be used for all digital signatures performed on records stored in contract vault 220. Every record saved in the vault is given a digital signature using this certificate.

In one example embodiment, CMS 108 may use an independent digital certificate vendor, such as VeriSign Inc. or a similar vendor, to issue the certificates used in the e-contracting process. The vendor may periodically, such as once a week, provide updated Certificate Revocation List (CRL) to CMS 108. The CRL indicates those digital certificates that have been revoked and are no longer valid. CMS 108 will use CRL to ensure the authenticity of every certificate presented to the system by system users.

Again with reference to FIG. 3, at step 365, e-contracting application 112 may update ownership log 228 and event log 232 with new contact data. The ownership log 228 entry may be created in the vault at the same time as the creation of the e-contract 224. The ownership log acts as an owner registry that records all transactions affecting changes in ownership or custody of all files in the vault. A new entry is created in the ownership log whenever an activity affecting the ownership of a contract in the vault 220 occurs. The following is a representation of one embodiment of the ownership log.

OWNERSHIP LOG

| | | | | | Digital |
|---|---|---|---|---|---|
| Event | Transaction | | Event | Requestor | Sig- |
| ID | Number | Date/Time | Description | ID | nature |
| 1 | 100001 | 1/27/2007 | Dealer Owned | JSMITH01 | DSIG D |
| | | 08:23:05 | | | |
| 2 | 100001 | 1/28/2007 | Finance Source | DJONES2 | DSIG D |
| | | 18:15:21 | X Owned | | |

The event log 232 may contain a history of every transaction affecting a file within the vault 220. Such history will include both authorized and unauthorized transactions. Each entry to the log may contain the ID of the person and/or program that requested the transaction, in addition to the date and time the transaction occurred. The following is a representation of one example embodiment of the event log 232.

EVENT LOG

| Event | Transaction | | | Requestor |
|---|---|---|---|---|
| ID | Number | Date/Time | Event Description | ID |
| 1 | 100001 | 1/27/2007 | Doc Generation | JSMITH01 |
| | | 12:00:01 | | |
| 2 | 100001 | 1/27/2007 | Apply Buyer Signature | JSMITH01 |
| | | 12:03:31 | | |
| 3 | 100001 | 1/27/2007 | Apply Co-buyer | JSMITH01 |
| | | 12:05:45 | Signature | |
| 4 | 100001 | 1/27/2007 | Apply Dealer Signature | JSMITH01 |
| | | 12:10:00 | | |
| 5 | 100001 | 1/28/2007 | Ownership change to | DJONES2 |
| | | 18:15:21 | Finance Source X | |

Lastly, at step 370, the e-contracting application 112 may digitally sign the ownership and event logs with digital signature “D” after every new entry to the log to assure authenticity of data records stored therein. It should be noted that in accordance with one example embodiment, when the finance source 104 accepts the distribution of the contract, the ownership is transferred to that finance source, which means the finance source's certificate is used to seal the contract and the AC may be transferred to the portion of the contract vault allocated to the contracts associated with that finance source. Once this happens, the contract may no longer be accessible to the contract originator and only to the finance source.

In one example embodiment, discloses a method for contracting for the acquisition by a customer of an asset offered by a vendor with financing provided by a third party finance source. The method includes storing finance source information for one or more finance sources. The finance source information may include one or more application worksheets for collecting credit application information from the customer and one or more contract templates for generating electronic contracts based on the collected credit application information. The method further includes acquiring from the customer credit application information using one or more application worksheets. The credit application information may include one or more of information describing the customer, information describing the asset and information describing proposed financing for the contract.

The method further includes selecting from the one or more contract templates a contract template associated with the given transaction, wherein selection is based on the credit application information, and generating an electronic contract based on the selected contract template and at least a portion of the collected credit application information. The method further includes providing the generated electronic contract to one or more contracting parties, including the customer, the vendor and one or more finance sources. The method further includes receiving one or more holographic signatures indicating execution of the contract by the contracting parties, including a customer signature, a vendor signature and a finance source signature. The method further includes generating an e-contract package by digitally signing each one of the electronic contract and the one or more holographic signatures using one or more digital signatures. The method further includes storing in a database the digitally signed e-contract package and one or more digital certificates associated with digital signatures.

The method further includes creating a contract event log including information about events of contract execution. The method further includes updating the event log after each transaction, and digitally signing the updated event log after each transaction. The method further includes creating a contract ownership log including records of change in ownership of the electronic contract. The method further includes assigning the electronic contract to the finance source. The method further includes updating the contract ownership log to indicate assignment of the contract, and digitally signing the updated contract ownership log. The method further includes in the e-contract package one or more supplemental forms, including finance source forms and vendor forms.

In yet another example embodiment, disclosed a method for contracting for an acquisition by a customer of an asset offered by a vendor with financing provided by a third party finance source. The method include generating an electronic contract responsive to one or more contract templates and credit application information, the credit application information including one or more of: information describing the customer, information describing the asset and information describing proposed financing for the contract. The method further includes providing the generated electronic contract to one or more contracting parties, the parties including the customer, the vendor and the finance source(s). The method further includes receiving one or more holographic signatures indicating execution of the contract by the contracting parties including one or more of a customer signature, a vendor signature and a finance source signature. The method further includes generating an e-contract package by digitally signing each one of the electronic contract and the one or more holographic signatures using one or more digital signatures. The method further includes storing the digitally signed e-contract package and one or more digital certificates associated with one or more digital signatures.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method for contracting for the acquisition by a customer of an asset offered by a vendor with financing provided by a third party finance source, the method comprising:
storing finance source information for one or more finance sources, the finance source information including one or more application worksheets for collecting credit application information from the customer and one or more contract templates for generating electronic contracts based on the collected credit application information;
acquiring from the customer credit application information using one or more application worksheets, the credit application information including one or more of information describing the customer, information describing the asset and information describing proposed financing for the contract;
selecting from the one or more contract templates a contract template associated with the given transaction, wherein selection is based on the credit application information;
generating an electronic contract based on the selected contract template and at least a portion of the collected credit application information;
providing the generated electronic contract to one or more contracting parties, including the customer, the vendor and one or more finance sources;
receiving one or more holographic signatures indicating execution of the contract by the contracting parties, including one or more of a customer signature, a vendor signature and a finance source signature;
generating an e-contract package by digitally signing each one of the electronic contract and the one or more holographic signatures using one or more digital signatures; and
storing in a database the digitally signed e-contract package and one or more digital certificates associated with one or more digital signatures.

2. The method of claim 1, wherein the step of acquiring credit application information includes:
submitting the acquired credit application information to a finance source for approval.

3. The method of claim 1, wherein the step of generating an electronic contract includes:
validating information in the contract template before generating an electronic contract.

4. The method of claim 1, further comprising:
creating a contract event log including information about events of contract execution.

5. The method of claim 3, further comprising:
updating the event log after each transaction, and
digitally signing the updated event log after each transaction.

6. The method of claim 1, further comprising:
creating a contract ownership log including records of change in ownership of the electronic contract.

7. The method of claim 6, further comprising:
assigning the electronic contract to the finance source.

8. The method of claim 7, further comprising:
updating the contract ownership log to indicate assignment of the contract, and
digitally signing the updated contract ownership log.

9. The method of claim 1, further comprising:
including in the e-contract package one or more supplemental forms, including finance source forms and vendor forms.

10. A system for contracting for an acquisition by a customer of an asset offered by a vendor with financing provided by a third party finance source, the system comprising:
a credit aggregation management component configured to
acquire from the customer credit application information using one or more application worksheets, the credit application information including one or more of information describing the customer, information describing the asset, and information describing the proposed financing for the contract; and
an e-contracting component configured to
select from one or more contract templates a contract template associated with the given transaction, wherein selection is based on the credit application information;
generate an electronic contract responsive to the selected contract templates and at least a portion of the finance-source-approved credit application information;
provide the generated electronic contract to one or more contracting parties, the parties including the customer, the vendor and one or more finance sources;
receive one or more holographic signatures indicating execution of the contract by the contracting parties, including one or more of a customer signature, a vendor signature and a finance source signature; and
generate an e-contract package by digitally signing each one of the electronic contract and the one or more holographic signatures using one or more digital signatures; and
a database configured to store the digitally signed e-contract package and one or more digital certificates associated with one or more digital signatures.

11. The system of claim 10, further comprising:
a holographic signature capture devices configured to
capture one or more holographic signatures, and
transmit the captured holographic signatures to the e-contracting component.

12. The system of claim 10, wherein the e-contracting component is further configured to validate information in the contract template before generating an electronic contract.

13. The system of claim 10, wherein the database is further configured to store one or more credit application worksheets and one or more contract templates.

14. The system of claim 10, further comprising:
a digitally signed event log including information about events of contract execution.

15. The system of claim 10, further comprising:
a digitally signed ownership log including contract ownership records.

16. A method for contracting for an acquisition by a customer of an asset offered by a vendor with financing provided by a third party finance source, the method comprising:
generating an electronic contract responsive to one or more contract templates and credit application information, the credit application information including one or more of: information describing the customer, information describing the asset and information describing proposed financing for the contract;
providing the generated electronic contract to one or more contracting parties, the parties including the customer, the vendor and the finance source(s);
receiving one or more holographic signatures indicating execution of the contract by the contracting parties including one or more of a customer signature, a vendor signature and a finance source signature;
generating an e-contract package by digitally signing each one of the electronic contract and the one or more holographic signatures using one or more digital signatures; and
storing the digitally signed e-contract package and one or more digital certificates associated with one or more digital signatures.

17. The method of claim 16, further comprising:
creating an event log including information about events of contract execution.

18. The method of claim 16, further comprising:
updating the event log after each event entry, and
digitally signing the updated event log.

19. The method of claim 16, further comprising:
creating an ownership log including contract ownership records.

20. The method of claim 19, further comprising:
assigning the electronic contract to the finance source.

21. The method of claim 20, further comprising:
updating the ownership log to indicate assignment of the contract, and
digitally signing the updated contract ownership log.
